(19) United States
(12) Patent Application Publication
(10) Pub. No.: US 2026/0135008 A1
(43) Pub. Date: May 14, 2026

(54) ULTRASOUND DEVICES AND METHODS FOR FUEL CHANNEL INSPECTION

(71) Applicant: ONTARIO POWER GENERATION INC., Toronto (CA)

(72) Inventors: Raymond TEN GROTENHUIS, Toronto (CA); Andres VILLEGAS, Toronto (CA); Andrew HONG, Toronto (CA); Yadav VERMA, Brampton (CA)

(73) Assignee: ONTARIO POWER GENERATION INC., Toronto (CA)

(21) Appl. No.: 19/120,481

(22) PCT Filed: Oct. 12, 2023
(86) PCT No.: PCT/CA2023/051353

§ 371 Date: Apr. 11, 2025

Related U.S. Application Data
(60) Provisional application No. 63/415,617, filed on Oct. 12, 2022.

(51) Int. Cl. G21C 17/017; G01N 29/22; G01N 29/265

(52) U.S. Cl. CPC G21C 17/017; G01N 29/225; G01N 29/265

(57) ABSTRACT

Devices and methods for ultrasound inspection of fuel channels. An ultrasound inspection device includes multiple arrays of ultrasound transducer (UT) elements positioned around its outer circumference. As the device is inserted into or withdrawn 2024/103152 from the bore of a pressure tube of the fuel channel, the UT elements are driven in an activation pattern, and data is collected from the UT elements in a collection pattern. The placement of the UT arrays, and the activation pattern and collection pattern of the UT elements, may be configured to generate overlapping circumferential UT scanning coverage as the device is displaced axially within the pressure tube.

### RELATED APPLICATION DATA

This application claims priority from U.S. provisional application No. 63/415,617 filed Oct. 12, 2022.

### FIELD

The present disclosure is related to devices and methods for non-destructive inspection of conduits, in particular devices and methods for non-destructive inspection of nuclear fuel channels using ultrasound sensors.

### BACKGROUND

Non-destructive methods for inspecting solid materials are known in the art, and are used for the inspection of pipes and other conduits, including fuel channels used in nuclear power plants. Ultrasound sensors are one known technology for determining various properties of conduits based on the shape and thickness of local regions of the conduit wall.

In particular, an array of ultrasound transducer elements (also called UT elements) may be used to capture data about a physical object, such as an inner or outer surface of a conduit and/or internal characteristics of the conduit wall (such as internal defects), using a Full Matrix Capture (FMC) technique.

International Publication WO 2013/044350 discloses a manipulator used for ultrasound inspection of pipe surfaces. The manipulator comprises a cuff fitted around a pipe circumference having an ultrasound array mounted on a shuttle. The shuttle moves around the cuff, scanning the circumference of the pipe using the Total Focusing Method, a version of the Full Matrix Capture technique for collecting and processing probe data. The reference sets out methods for calibrating equipment and software, scanning the pipe surfaces, and collecting and analyzing the probe data using the Total Focusing Method to reconstruct models of the pipe surfaces and/or the interiors of the pipe walls. The present disclosure relies upon the teachings of this previous publication and hereby incorporates those teachings by reference.

In the context of nuclear fuel channel inspection, existing approaches to ultrasound inspection use a tool fitted with an array of ultrasound transducers to inspect the interior of a fuel channel. Each fuel channel includes a pressure tube (PT) suspended inside of a calandria tube (also called a sleeve) by means of end fitting and spacers. The ultrasound inspection tool is inserted into the interior (i.e. the bore) of the pressure tube, and the ultrasound transducers, positioned on the exterior surface of the tool facing toward the interior surface of the pressure tube, collect ultrasound data (e.g., FMC data) as the tool is axially inserted or withdrawn to collect ultrasound data around the inner circumference of the pressure tube while moving along the axial dimension of the pressure tube.

However, physical constraints of the fuel channel and the tool, as well as data communication constraints, typically limit the number and placement of UT elements of the tool, thereby limiting spatial coverage and resolution of the ultrasound inspection data. The UT elements used in existing approaches typically transmit ultrasound to a small number (e.g., 12) of specific locations of the interior surface of the conduit. In some approaches, the number of UT elements available for fuel channel scanning is even smaller, because some of the spatial locations otherwise used for UT elements may need to be reserved for other sensors, such as water temperature sensors. This can result in loss of signal in the case of deformation or movement of the conduit. In some applications, the small number of UT elements may also have required the tool to be rotated within the fuel channel in order to perform a complete UT scan; this rotation has a tendency to introduce unwanted artifacts that further reduce the accuracy of the scan, such as displacement of the fuel channel due to vibrations.

Accordingly, it is desirable to provide a device for ultrasound inspection of fuel channels that overcomes one or more of the limitations of existing approaches.

### SUMMARY

In various examples, the present disclosure describes devices and methods for ultrasound inspection of fuel channels. In some embodiments, an ultrasound inspection device includes multiple arrays of UT elements positioned around various portions of the outer circumference of an ultrasound array section. Each such array includes multiple UT elements configured to transmit and/or sense ultrasound, typically in a liquid medium. The device is inserted into the interior of a pressure tube, a subset of the UT elements are driven in an activation pattern, and data is collected from a subset of the UT elements in a collection pattern. The relative placement of the arrays of UT elements, the relative placement of the individual UT elements of each array, the activation pattern, and the collection pattern may be configured to optimize the spatial coverage, speed, accuracy, resolution, and/or reliability of ultrasound data collection.

As used herein, the terms “UT” and “UT element” refer to an ultrasound transducer unless otherwise specified. In some examples, a UT element may perform only transmitting or only receiving functions, in which case an ultrasound transmitter or an ultrasound receiver, respectively, may be used in place of an ultrasound transducer. In some examples, a single UT element may include a dedicated transmitter and a dedicated receiver.

As used herein, the terms “UT array” and “ultrasound array” refer to an array of UT elements arranged in sequence along a line, arc, or other linear curve.

In some example aspects, the present disclosure describes a device for inspecting a conduit, comprising a body configured to be inserted into an interior cavity of the conduit along an axial dimension of the conduit, such that a longitudinal axis of the body is substantially aligned with the axial dimension of the conduit. A plurality of ultrasound transducer (UT) arrays, each UT array being located at a respective axial location along the longitudinal axis and defining an arc along a portion of a circumference of the body are provided, each UT array comprising a plurality of UT elements, each respective UT element being located at a respective circumferential position along the arc of the UT array, the circumferential position corresponding to a circumferential portion of the conduit.

Control circuitry is configured to activate the UT elements of the UT arrays according to an activation pattern such that each UT element transmits ultrasound at each of a plurality of axial locations of the respective circumferential portion of the conduit. Data collection circuitry is configured to collect ultrasound data from the UT elements of the UT arrays according to a collection pattern such that the ultrasound data is collected from each respective UT element with respect to each of a plurality of axial locations of the respective circumferential portion of the conduit.

In some embodiments, the activation pattern and collection pattern are configured to perform pitch-catch ultrasound scanning, such that one or more of the UT elements of the UT arrays collect ultrasound data while one or more other UT elements of the UT arrays are transmitting ultrasound. In some embodiments, the activation pattern and collection pattern are configured to perform Full Matrix Capture ultrasound scanning.

In some embodiments the plurality of UT arrays includes a left UT array defining an arc of less than 180 degrees on a left portion of the body, at a left-right array axial position and a right UT array defining an arc of less than 180 degrees on a right portion of the body, at the left-right array axial position. Optionally, the plurality of UT elements of the left UT array and right UT array are oriented to transmit and receive ultrasound in a direction substantially perpendicular to the longitudinal axis of the body.

In some embodiments the plurality of UT arrays includes a top UT array defining an arc of less than 180 degrees on a top portion of the body, at a top-bottom array axial position and a bottom UT array defining an arc of less than 180 degrees on a bottom portion of the body, at the top-bottom array axial position. Optionally, the plurality of UT elements of the top UT array and bottom UT array are oriented to transmit and receive ultrasound in a direction substantially perpendicular to the longitudinal axis of the body.

In some embodiments the plurality of UT arrays includes a first conical UT array defining an arc of less than 180 degrees around a first circumferential portion of the body at a first conical array axial position, each UT element of the first UT array being oriented to transmit and receive ultrasound in a diagonal direction radially outward from, and toward a forward direction of the longitudinal axis of the body and a second conical UT array defining an arc of less than 180 degrees around a second circumferential portion of the body at a second conical array axial position, each UT element of the second UT array being oriented to transmit and receive ultrasound in a diagonal direction radially outward from, and toward a rearward direction of, the longitudinal axis of the body.

Optionally, the activation pattern and collection pattern are configured to perform pitch-catch ultrasound scanning, such that one or one UT elements of one array of the first conical array and the second conical array collects ultrasound data, while one or one UT elements of the other array of the first conical array and the second conical array transmits ultrasound. In an embodiment, the plurality of UT elements of at least one UT array comprises at least 250 UT elements or at least 500 UT elements.

Optionally the data collection circuitry is further configured to process the ultrasound data collected from the UT elements to identify a local irregularity in an interior surface of the conduit at one or more locations. In some embodiments, the data collection circuitry is further configured to process the ultrasound data collected from the UT elements to identify a local irregularity in an exterior surface of the conduit at one or more locations. Optionally the local irregularity comprises at least one of the following: a thin portion, a blister, and a scratch.

In some embodiments the data collection circuitry is further configured to process the ultrasound data collected from the UT elements to identify a deformation of the conduit at one or more locations. Optionally the deformation comprises at least one of the following: sagging and ovality.

Optionally a tether is attached to the body, the tether comprising a communication link operably coupled to the control circuitry and the data collection circuitry and a power link for providing electrical power to the UT elements. The communication link may be an optical communication link.

Optionally the control circuitry is further configured to receive control data from the communication link and activate the UT elements according to the activation pattern based on the control data. In some embodiments the data collection circuitry is configured to process the ultrasound data collected from the UT elements to generate inspection data and transmit the inspection data on the communication link.

The invention also teaches a device for inspecting a conduit, comprising a body configured to be inserted into an interior cavity of the conduit along an axial dimension of the conduit, such that a longitudinal axis of the body is substantially aligned with the axial dimension of the conduit. A plurality of UT arrays, each UT array being located at a respective axial location along the longitudinal axis and defining an arc along a portion of a circumference of the body, each UT array comprise a plurality of ultrasound transducer (UT) elements, each respective UT element being located at a respective circumferential position along the arc of the UT array, the circumferential position corresponding to a circumferential portion of the conduit. Control circuitry is configured to activate the UT elements of the UT arrays according to an activation pattern such that each UT element transmits ultrasound at each of a plurality of axial locations of the respective circumferential portion of the conduit. Data collection circuitry configured to collect ultrasound data from the UT elements of the UT arrays according to a collection pattern such that the ultrasound data is collected from each respective UT element with respect to each of a plurality of axial locations of the respective circumferential portion of the conduit. The wherein the plurality of UT arrays includes a first pair of UT arrays each defining an arc of less than 180 degrees on a pair of substantially opposite circumferential portions of the body, at a first axial position and a second pair of UT arrays each defining an arc of less than 180 degrees on a pair of substantially opposite circumferential portions of the body, at a second axial position. The area covered by the first pair of arrays and area covered by the second pair of arrays collectively encompasses an entire longitudinal axis of the conduit.

Optionally the first pair of UT arrays comprises a first pair of conical UT arrays, each UT element of the first pair of UT arrays being oriented to transmit and receive ultrasound in a diagonal direction radially outward from, and toward a forward direction of, the longitudinal axis of the body and the second pair of UT arrays comprises a second pair of conical UT arrays, each UT element of the second pair of UT arrays being oriented to transmit and receive ultrasound in a diagonal direction radially outward from, and toward a rearward direction of, the longitudinal axis of the body.

Optionally the conduit is a pressure tube of a fuel channel. Optionally the device of claims 1 to 23, wherein the device is tubular.

The invention also provides a method for inspecting a conduit, comprising inserting, into an interior cavity of the conduit along an axial dimension of the conduit, a device such that a longitudinal axis of the device is substantially aligned with an axial dimension of the conduit. The device includes a plurality of ultrasound transducer (UT) elements including a first plurality of UT elements at a first axial location along the longitudinal axis and defining a first partial circumferential portion of the device with respect to the longitudinal axis, and a second plurality of UT elements at a second axial location along the longitudinal axis and defining a second partial circumferential portion of the device with respect to the longitudinal axis. The first partial circumferential portion and the second partial circumferential portion have a non-zero circumferential overlap. The method displaces the device with respect to the axial dimension and while displacing the device with respect to the axial dimension: activating the UT elements according to an activation pattern such that each UT element transmits ultrasound at each of a plurality of axial locations of the conduit; and collecting ultrasound data from the UT elements according to a collection pattern such that the ultrasound data is collected from each respective UT element with respect to each of a plurality of axial locations of the conduit.

### BRIEF DESCRIPTION OF THE DRAWINGS

Reference will now be made, by way of example, to the accompanying drawings which show example embodiments of the present application, and in which:

FIG. 1 is an front left perspective view of an ultrasound inspection device, in accordance with examples of the present disclosure;

FIG. 2 is a right side elevation view of an ultrasound array section of the ultrasound inspection device of FIG. 1;

FIG. 3A is a front cross-sectional elevation view through line A of the ultrasound array section of FIG. 2;

FIG. 3B is a front cross-sectional elevation view through line B of the ultrasound array section of FIG. 2;

FIG. 4 is a front cross-sectional elevation view of a calandria tube, a pressure tube, and the ultrasound array section of FIG. 2 inserted into the interior of the pressure tube, showing a cross section of the ultrasound array section through line C of FIG. 2; and

FIG. 5 is a flowchart showing steps of an example method for ultrasound inspection of a fuel channel, in accordance with examples of the present disclosure.

FIG. 6 is a graph of full matrix capture results based on ultrasound beam directivity.

FIG. 7 is a graph of full matrix capture results based on ultrasound beam directivity.

FIG. 8 is a graph of full matrix capture results based on ultrasound beam directivity.

FIG. 9 is a graph of full matrix capture results based on ultrasound beam directivity.

Similar reference numerals may have been used in different figures to denote similar components.

### DESCRIPTION OF EXAMPLE EMBODIMENTS

The present disclosure describes example devices and methods for ultrasound inspection of fuel channels, using a device having multiple ultrasound transducer (UT) elements arranged around the circumference of an ultrasound array section of the device to perform Full Matrix Capture (FMC) ultrasound data collection.

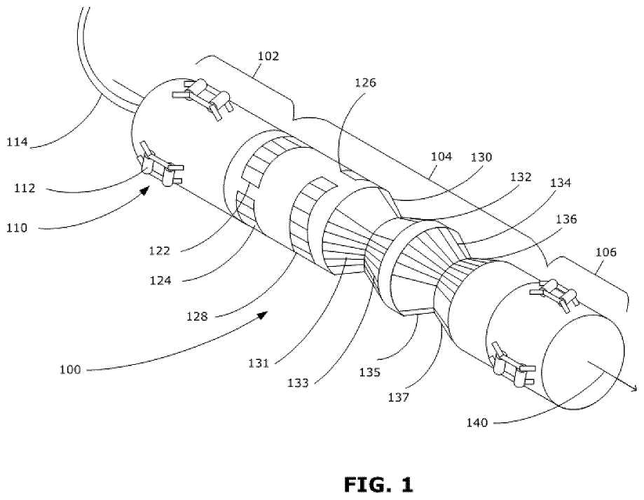

FIG. 1 shows an ultrasound inspection device 100. The device 100 has a body including a forward section 106, an ultrasound array section 104, and a rear section 102. The device 100 is longitudinal in shape and configured to be inserted into the interior cavity (i.e., the bore) of a pressure tube of a fuel channel, forward section 106 first, as defined by a longitudinal axis 140 shown pointing in the forward direction indicating the direction of insertion. In an embodiment, the device is tubular in shape.

The illustrated device 100 includes a tether 114 extending out of a rear opening of the pressure tube for communication with equipment exterior to the fuel channel. The tether 114 may include a communication link (such as an electrical communication link or an optical communication link) for bidirectional communication with external data processing equipment and/or a power link for supplying electrical power from an external power source.

The illustrated device 100 includes spacers 110 on the forward section 106 and rear section 102. There may be multiple spacers 110 at each of one or more axial locations, e.g., three spacers 110 at three equidistant circumferential positions around a first axial position on the rear section 102, and another three spacers 110 at three equidistant circumferential positions around a second axial position on the forward section 106. The spacers 110 may be operable to radially center the device 100 within the circular interior cavity of the pressure tube, for example by using actuators to extend radially outward from the device body, or by being biased radially outward by biasing means such as springs. The spacers 110 may include rollers 112 for assisting with axial displacement of the device 100 within the pressure tube; in some embodiments, the rollers 112 may be actuated (e.g., using electric motors or hydraulics) to actively displace the device 100 axially within the pressure tube. In some embodiments, the forward section 106 may not be present, and the ultrasound array section 104 may constitute a head (i.e. forward-most portion) of the device 100. In some such embodiments, sets of spacers 110 may be placed at two or more axially separated locations of the rear section 102 to assist in centering and stabilizing the tool within the conduit.

The ultrasound array section 104 of the device 100 includes a plurality of UT elements, grouped into a plurality of UT arrays. The UT arrays are shown as a top UT array 122, a bottom UT array 124, a left UT array 126, a right UT array 128, a left forward conical UT array 130, a right forward conical UT array 131, a left rearward conical UT array 132, a right rearward conical UT array 133, a top forward conical UT array 134, a bottom forward conical UT array 135, a top rearward conical UT array 136, and a bottom rearward conical UT array 137. Each UT element is affixed to the ultrasound array section 104 at a respective circumferential position about the body of the device 100, defined relative to the longitudinal axis 140. The positioning of these UT elements allows each UT element to perform ultrasound transmission and/or ultrasound reception at a corresponding circumferential portion of the interior of the pressure tube or other conduit being inspected when the device 100 in inserted into the bore of the pressure tube such that the longitudinal axis 140 is substantially aligned with the axial dimension of the pressure tube. As the device 100 is displaced axially within the conduit (i.e. along the length, i.e. the axial dimension, of the pressure tube or conduit), each UT element traverses an axial length of its respective circumferential portion of the interior surface of the conduit, generating ultrasound data for an axial strip or a plurality of axial locations of its respective circumferential portion of the conduit. Collectively, the area covered by the first pair of arrays and the area covered by the second pair of arrays collectively encompasses the entire longitudinal axis of the conduit.

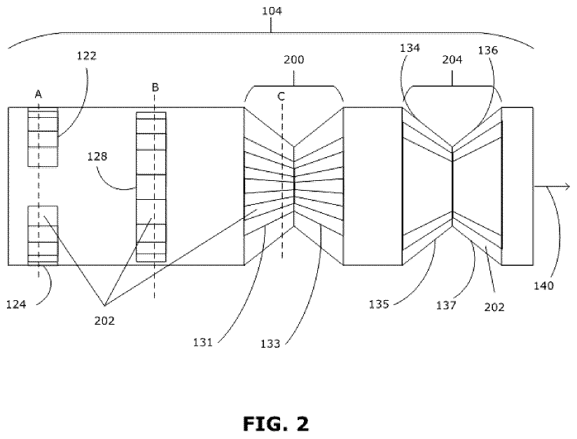

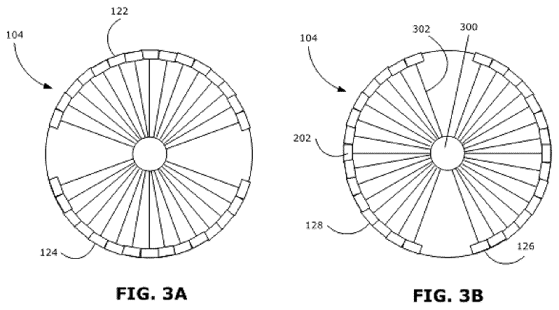

FIG. 2 shows a right side of the ultrasound array section 104 of an example ultrasound inspection device. The ultrasound array section 104 includes a pair of top and bottom array, top UT array 122 and bottom UT array 124, at a first axial location. A cross-sectional view through line A at the first axial location is shown in FIG. 3A, described below. The ultrasound array section 104 includes a pair of left and right array, left UT array 126 (not visible in FIG. 2) and right UT array 128, at a second axial location. A cross-sectional view through line B at the second axial location is shown in FIG. 3B, described below. The individual UT elements 202 of the top UT array 122, bottom UT array 124, left UT array 126, and right UT array 128 are oriented to transmit and receive ultrasound in a direction substantially perpendicular to the longitudinal axis 140.

The ultrasound array section 104 also includes two conical array sub-sections, a first conical array subsection 200 and a second conical array subsection 204. The first conical array subsection 200 includes a forward-facing conical surface on which are positioned the left forward conical UT array 130 (not visible in FIG. 2) and the right forward conical UT array 131, and a rearward-facing conical surface on which are positioned the left rearward conical UT array 132 (not visible in FIG. 2) and the right rearward conical UT array 133. The second conical array subsection 204 includes a forward-facing conical surface on which are positioned the top forward conical UT array 134 and the bottom forward conical UT array 135, and a rearward-facing conical surface on which are positioned the top rearward conical UT array 136 and the bottom rearward conical UT array 137. Each conical surface is located at a distinct axial location relative to the other conical surfaces.

In some embodiments, the arrays on a forward-facing conical surface (such as left forward conical UT array 130 and right forward conical UT array 131) are oriented to transmit ultrasound (e.g., to operate as pitch UT elements in a pitch-catch ultrasound scanning operation) diagonally forward and axially outward, and the arrays on the corresponding rearward-facing conical surface (such as left rearward conical UT array 132 and right rearward conical UT array 133) are configured to receive ultrasound (e.g., to operate as catch UT elements in the pitch-catch ultrasound scanning operation) diagonally rearward and axially outward. These functions may also be reversed in some examples, i.e., the rearward arrays pitch and the forward arrays catch. In some embodiments, the UT elements 202 of each array are configured to both transmit/pitch and receive/catch in different operation modes, such as at different epochs of an activation pattern or collection pattern, as described below.

In some embodiments, each array 122, 124, 126, 128, 130, 131, 132, 133, 134, 135, 136, 137 defines an arc around an incomplete circumferential portion of the body of the ultrasound array section 104. In some embodiments, the arcs are each less than 180 degrees, i.e. each array covers less than half of the circumference of the ultrasound array section 104. This may allow circuitry or other components to be located in the circumferential portion of the ultrasound array section 104 not covered by UT arrays. However, it may mean that the UT arrays at a given axial location do not effect 360 degree ultrasound scanning coverage of the interior surface of the conduit. Thus, in some embodiments the UT arrays at a second axial location may be configured such that the circumferential portions of the ultrasound array section 104 occupied by the UT arrays at the first axial location (e.g., top UT array 122 and bottom UT array 124) overlap with the circumferential portions of the ultrasound array section 104 occupied by the UT arrays at the second axial location (e.g., left UT array 126 and right UT array 128).

FIG. 3A is a front cross-sectional view through line A at the first axial position of the ultrasound array section 104 of FIG. 2, showing the top UT array 122 and bottom UT array 124.

FIG. 3B is a front cross-sectional view through line B at the second axial position of the ultrasound array section 104 of FIG. 2, showing the left UT array 126 and right UT array 128.

It will be appreciated that each array 122, 124, 126, 128 in FIGS. 3A-3B occupies less than 180 degrees of the circumference of the ultrasound array section 104, but the four arrays 122, 124, 126, 128 jointly overlap such that they cover a 360 degree circumference of the ultrasound array section 104. Thus, if all four arrays 122, 124, 126, 128 are used to perform ultrasonic scanning of an interior surface of a conduit while the device 100 is displaced axially (i.e., along axis 140 shown in FIG. 1), all circumferential portions of the interior surface of the conduit will be scanned.

The ultrasound array section 104 includes an instrumentation core 300 containing circuitry for controlling the UT elements 202 and collecting ultrasound data from the UT elements 202. In the example embodiment shown in FIG. 2, the UT elements 202 are arranged uniformly about the circumference of the ultrasound array section 104, such that each UT element 202 is positioned to inspect an equally-sized circumferential portion (i.e. equal-length circumferential arcs) of the conduit.

An electrical link 302 connects each UT element 202 to the instrumentation core 300. The instrumentation core 300 may contain circuitry configured to send the control signals to the UT elements 202, via the electrical links 302, in accordance with an activation pattern. Similarly, the instrumentation core 300 may contain circuitry configured to collect the ultrasound data from the UT elements 202 via the electrical links 302 according to a collection pattern.

The instrumentation core 300 may include one or more circuit components, such as one or more printed circuit boards (PCBs) and/or application-specific integrated circuits (ASICs). In some embodiments, the instrumentation core 300 includes an optical modulator and/or an optical demodulator, such as an electro-optical modulator (EOM) and/or a photodiode, for converting electrical signals to the optical domain. The communication link of the tether 114 (see FIG. 1) may be an optical link in some embodiments. In some examples, the instrumentation core 300 may include control circuitry configured to receive control data from the tether 114 (such as multiplexed optical signal data), and to activate the UT elements 202 according to the activation pattern based on the received control data. In some examples, the instrumentation core 300 may include data collection circuitry configured to receive ultrasound data from the UT elements 202 according to the collection pattern, and to transmit inspection data via the tether 114 (such as multiplexed optical signal data) based on the ultrasound data. The control data may be generated by control equipment located outside of the conduit and sent to the device 100 via the tether 114. The inspection data may be received over the tether 114 by data processing equipment located outside of the conduit and processed for analysis. In some embodiments, the control data and inspection data are multiplexed and communicated bidirectionally (i.e. control data to the device 100, inspection data from the device 100) over a multiplexed or bidirectional communication link, such as an optical or electrical communication link. In some examples, the inspection data is sent over an optical communication link, whereas the control data is received over an electrical communication link, because the control data is typically low volume relative to the inspection data.

In some embodiments, the tether 114 may also include a power link for supplying external power from an external power source to the UT elements 202 and/or other powered components of the device 100 (such as actuated spacers 110 and/or rollers 112). In some embodiments, the device 100 may include an internal power source for powering one or more of its powered components.

In some embodiments, one or more of the UT arrays of the device 100 may include a large number of UT elements 202, such as 256 UT elements or 512 UT elements (i.e. 256 pairs of pitch-catch UT elements) for a total of 2048 elements. By including a large number of UT elements 202, such as 250 or more UT elements 202, or 500 or more UT elements 202, the device 100 may be capable of generating high-resolution, reliable, accurate FMC ultrasound scanning data for a given length of conduit in a relatively short period of time.

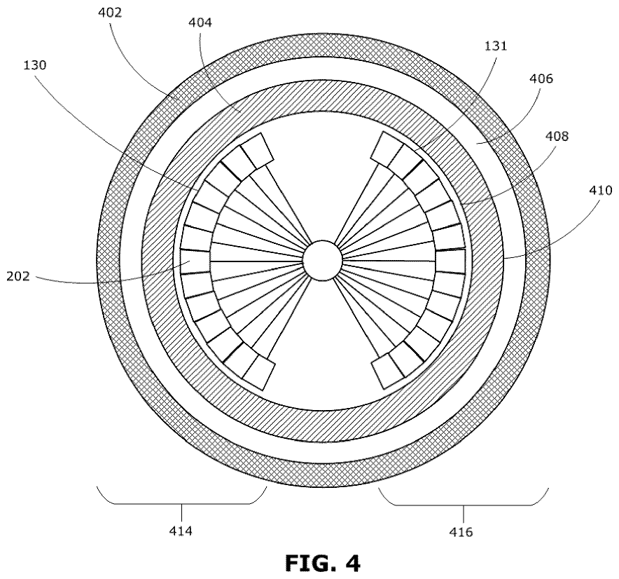

FIG. 4 shows a front cross-sectional view of a calandria tube 402, a pressure tube 404, and the ultrasound array section 104 of the ultrasound inspection device 100 through the first forward-facing conical surface at line C of FIG. 2, showing the ultrasound inspection device 100 inserted into the interior of the pressure tube 404. In operation, the spacers 110 (not shown) of the device 100 radially center the device 100 within the pressure tube 404 such that the UT elements 202 of the left forward conical UT array 130 and right forward conical UT array 131 are oriented diagonally forward and radially outward toward an interior surface 408 of the pressure tube 404. When some subset of the UT elements 202 are activated according to the activation pattern, and ultrasound data is collected by some other subset of the UT elements 202, the ultrasonic waves propagate through a medium (e.g., water) filling the space between the UT elements 202 and the interior surface 408 of the pressure tube 404. The ultrasound data collected by the UT elements 202 represents the ultrasonic waves present at the location of each respective UT element 202. The ultrasound data may be processed by the instrumentation code 300 and/or by external equipment to detect multiple properties of the pressure tube 404, and/or its interior surface 408 and/or external surface 410, and/or the interiors of the pressure tube walls (between the interior surface 408 and external surface 410), based on detected ultrasound wave patterns. In some examples, local irregularities of the pressure tube 404 may be detected at one or more locations, such as thin portions, blisters, and/or scratches. In some examples, deformation of the pressure tube 404 may be detected at one or more locations, such as sagging and/or ovality.

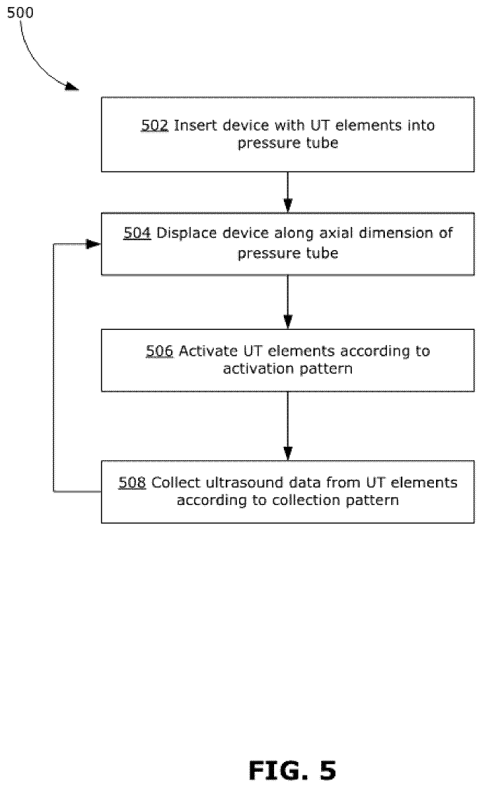

FIG. 5 shows steps of an example method 500 for ultrasound inspection of a conduit, such as a pressure tube of a fuel channel. Method 500 will be described in reference to ultrasound inspection device 100 (see FIG. 1). However, it will be appreciated that other means may be used to perform the steps of method 500.

At 502, a device 100 is inserted into an interior cavity of a conduit, along an axial dimension of the conduit, such that a longitudinal axis 140 of the device 100 is substantially aligned with an axial dimension of the conduit. The device includes a plurality of UT elements 202, including a first plurality of UT elements 202 at a first axial location along the longitudinal axis 140 (e.g., top UT array 122 and bottom UT array 124 at the first axial location) and a second plurality of UT elements 202 at a second axial location along the longitudinal axis 140 (e.g., left UT array 126 and right UT array 128 at the second axial location). The first plurality of UT elements 202 defines a first partial circumferential portion of the device with respect to the longitudinal axis 140, and the second plurality of UT elements 202 defines a second partial circumferential portion of the device with respect to the longitudinal axis 140. In some examples, the first partial circumferential portion and the second partial circumferential portion have a non-zero circumferential overlap, as described above.

At 504, the device is displaced with respect to the axial dimension of the conduit (i.e., either withdrawn or inserted).

At 506, a subset of the UT elements 202 are activated according to an activation pattern.

At 508, ultrasound data is collected from the UT elements 202 according to a collection pattern.

Steps 504, 506, and 508 may be repeated continuously or discretely such that each UT element 202 transmits ultrasound at each of a plurality of axial locations of the conduit, and the ultrasound data is collected from each respective UT element 202 with respect to each of a plurality of axial locations of the conduit.

### EXAMPLES OF RESULTS

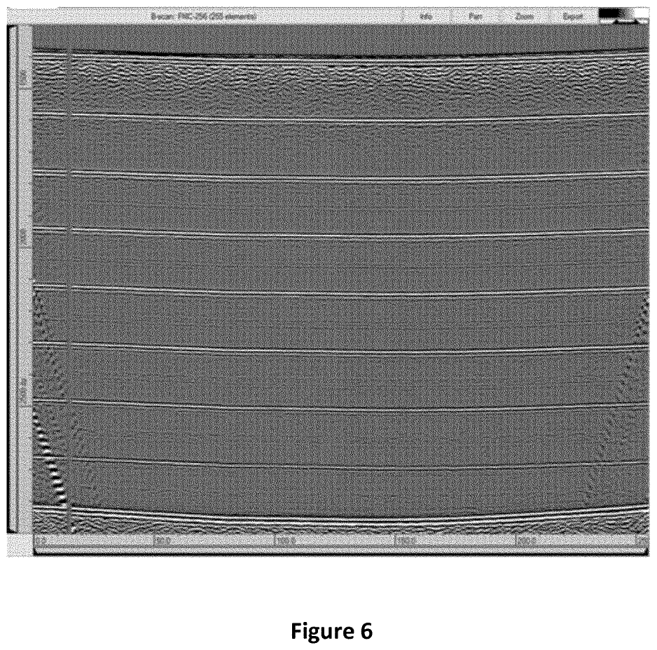

FIG. 6 is a graph of full matrix capture results based on ultrasound beam directivity showing the main diagonal of the FMC data set based on data acquired on a new sample of the interior of a calandria (pressure) tube without any flaws.

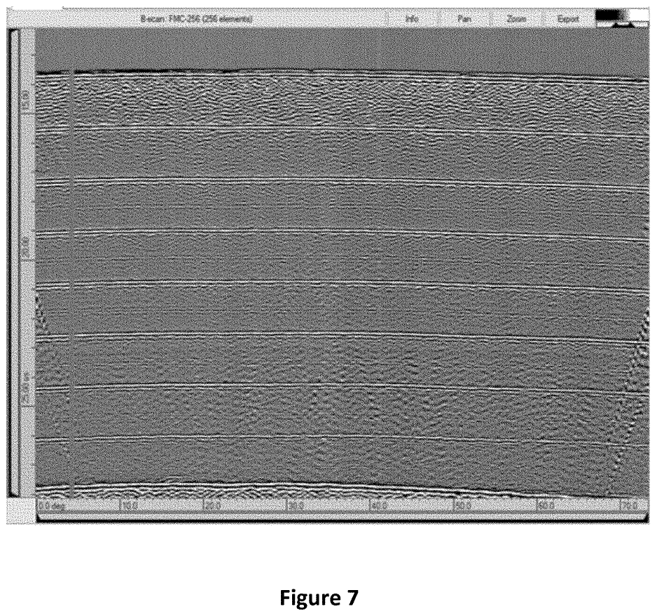

FIG. 7 is a graph of full matrix capture results showing an ex-service calandria (pressure) tube sample without any flaws. Note the heightened level of noise and degraded response.

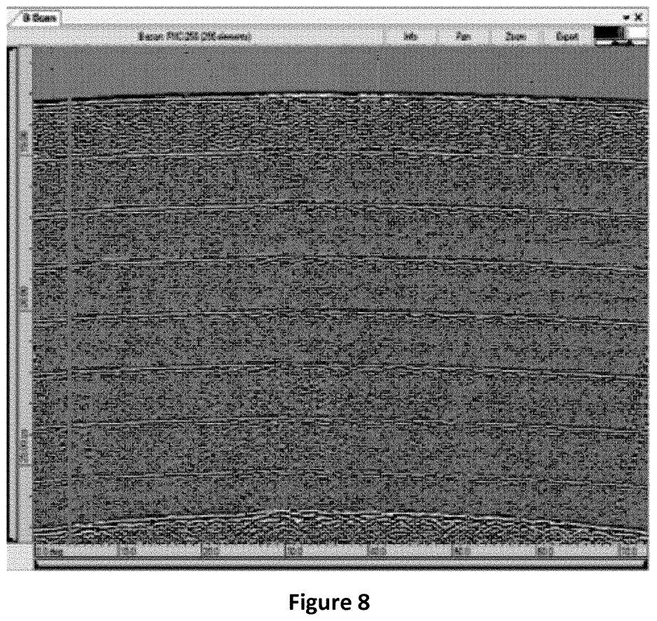

FIG. 8 is a graph of full matrix capture results showing an ex-service calandria (pressure) tube sample with a corroded inside surface. Note the further heightened level of noise and degraded response.

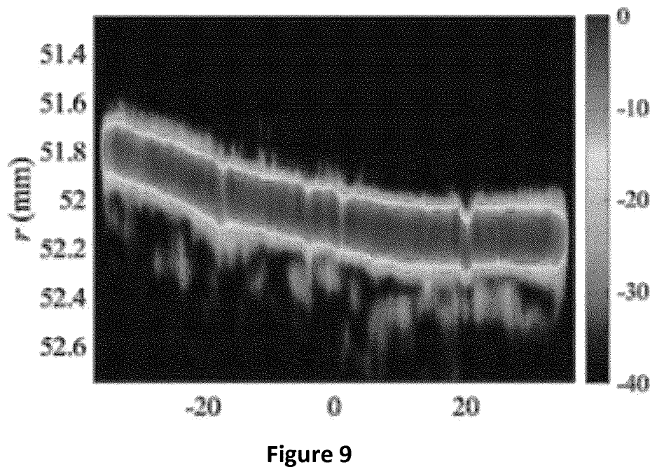

FIG. 9 is a colour visual based on full matrix capture results of an an ex-service calandria (pressure) tube sample showing a visualization of the gouges and scratches the sample endured from service use.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A device for inspecting a conduit, comprising:
a body configured to be inserted into an interior cavity of the conduit along an axial dimension of the conduit, such that a longitudinal axis of the body is substantially aligned with the axial dimension of the conduit;
a plurality of ultrasound transducer (UT) arrays, each UT array being located at a respective axial location along the longitudinal axis and defining an arc along a portion of a circumference of the body, each UT array comprising:
a plurality of UT elements, each respective UT element being located at a respective circumferential position along the arc of the UT array, the circumferential position corresponding to a circumferential portion of the conduit;
control circuitry configured to activate the UT elements of the UT arrays according to an activation pattern such that each UT element transmits ultrasound at each of a plurality of axial locations of the respective circumferential portion of the conduit; and
data collection circuitry configured to collect ultrasound data from the UT elements of the UT arrays according to a collection pattern such that the ultrasound data is collected from each respective UT element with respect to each of a plurality of axial locations of the respective circumferential portion of the conduit,
wherein each respective UT element is configured to transmit and sense ultrasound through a liquid medium between the body and the conduit.

2. The device of claim 1, wherein:
the activation pattern and collection pattern are configured to perform pitch-catch ultrasound scanning, such that one or more of the UT elements of the UT arrays collect ultrasound data while one or more other UT elements of the UT arrays are transmitting ultrasound.

3. The device of claim 1, wherein:
the activation pattern and collection pattern are configured to perform Full Matrix Capture ultrasound scanning.

4. The device of claim 1, wherein:
the plurality of UT arrays includes:
a left UT array defining an arc of less than 180 degrees on a left portion of the body, at a left-right array axial position; and
a right UT array defining an arc of less than 180 degrees on a right portion of the body, at the left-right array axial position.

5. The device of claim 4, wherein:
the plurality of UT elements of the left UT array and right UT array are oriented to transmit and receive ultrasound in a direction substantially perpendicular to the longitudinal axis of the body.

6. The device of any claim 1, wherein:
the plurality of UT arrays includes:
a top UT array defining an arc of less than 180 degrees on a top portion of the body, at a top-bottom array axial position; and
a bottom UT array defining an arc of less than 180 degrees on a bottom portion of the body, at the top-bottom array axial position.

7. (canceled)

8. The device of claim 1, wherein:
the plurality of UT arrays includes:
a first conical UT array defining an arc of less than 180 degrees around a first circumferential portion of the body at a first conical array axial position, each UT element of the first UT array being oriented to transmit and receive ultrasound in a diagonal direction radially outward from, and toward a forward direction of the longitudinal axis of the body; and
a second conical UT array defining an arc of less than 180 degrees around a second circumferential portion of the body at a second conical array axial position, each UT element of the second UT array being oriented to transmit and receive ultrasound in a diagonal direction radially outward from, and toward a rearward direction of, the longitudinal axis of the body.

9. The device of claim 8, wherein:
the activation pattern and collection pattern are configured to perform pitch-catch ultrasound scanning, such that:
one or more UT elements of one array of the first conical array and the second conical array collects ultrasound data, while
one or more UT elements of the other array of the first conical array and the second conical array transmits ultrasound.

10-11. (canceled)

12. The device of claim 1, wherein:
the data collection circuitry is further configured to process the ultrasound data collected from the UT elements to identify a local irregularity in an interior surface of the conduit at one or more locations.

13. The device of claim 1, wherein:
the data collection circuitry is further configured to process the ultrasound data collected from the UT elements to identify a local irregularity in an exterior surface of the conduit at one or more locations.

14. The device of claim 12, wherein:
the local irregularity comprises at least one of the following: a thin portion, a blister, and a scratch.

15. The device of claim 1, wherein:
the data collection circuitry is further configured to process the ultrasound data collected from the UT elements to identify a deformation of the conduit at one or more locations.

16. The device of claim 15, wherein:
the deformation comprises at least one of the following: sagging and ovality.

17. The device of claim 1, further comprising:
a tether attached to the body, the tether comprising:
a communication link operably coupled to the control circuitry and the data collection circuitry; and
a power link for providing electrical power to the UT elements.

18. The device of claim 17, wherein:
the communication link comprises an optical communication link.

19. The device of claim 17, wherein:
the control circuitry is further configured to:
receive control data from the communication link; and
activate the UT elements according to the activation pattern based on the control data.

20. The device of claim 17, wherein:
the data collection circuitry is configured to:
process the ultrasound data collected from the UT elements to generate inspection data; and
transmit the inspection data on the communication link.

21. A device for inspecting a conduit, comprising:
a body configured to be inserted into an interior cavity of the conduit along an axial dimension of the conduit, such that a longitudinal axis of the body is substantially aligned with the axial dimension of the conduit;
a plurality of UT arrays, each UT array being located at a respective axial location along the longitudinal axis and defining an arc along a portion of a circumference of the body, each UT array comprising:
a plurality of ultrasound transducer (UT) elements, each respective UT element being located at a respective circumferential position along the arc of the UT array, the circumferential position corresponding to a circumferential portion of the conduit;
control circuitry configured to activate the UT elements of the UT arrays according to an activation pattern such that each UT element transmits ultrasound at each of a plurality of axial locations of the respective circumferential portion of the conduit; and
data collection circuitry configured to collect ultrasound data from the UT elements of the UT arrays according to a collection pattern such that the ultrasound data is collected from each respective UT element with respect to each of a plurality of axial locations of the respective circumferential portion of the conduit;
wherein the plurality of UT arrays includes:
a first pair of UT arrays each defining an arc of less than 180 degrees on a pair of substantially opposite circumferential portions of the body, at a first axial position; and
a second pair of UT arrays each defining an arc of less than 180 degrees on a pair of substantially opposite circumferential portions of the body, at a second axial position, and wherein area covered by the first pair of arrays and area covered by the second pair of arrays collectively encompasses an entire longitudinal axis of the conduit.

22. The device of claim 21, wherein:
the first pair of UT arrays comprises a first pair of conical UT arrays, each UT element of the first pair of UT arrays being oriented to transmit and receive ultrasound in a diagonal direction radially outward from, and toward a forward direction of, the longitudinal axis of the body; and
the second pair of UT arrays comprises a second pair of conical UT arrays, each UT element of the second pair of UT arrays being oriented to transmit and receive ultrasound in a diagonal direction radially outward from, and toward a rearward direction of, the longitudinal axis of the body.

23-24. (canceled)

25. A method for inspecting a conduit, comprising:
inserting, into an interior cavity of the conduit along an axial dimension of the conduit, a device;
such that a longitudinal axis of the device is substantially aligned with an axial dimension of the conduit;
the device including a plurality of ultrasound transducer (UT) elements including:
a first plurality of UT elements at a first axial location along the longitudinal axis and defining a first partial circumferential portion of the device with respect to the longitudinal axis;
a second plurality of UT elements at a second axial location along the longitudinal axis and defining a second partial circumferential portion of the device with respect to the longitudinal axis;
the first partial circumferential portion and the second partial circumferential portion having a non-zero circumferential overlap;
displacing the device with respect to the axial dimension; and
while displacing the device with respect to the axial dimension:
activating the UT elements according to an activation pattern such that each UT element transmits ultrasound at each of a plurality of axial locations of the conduit; and
collecting ultrasound data from the UT elements according to a collection pattern such that the ultrasound data is collected from each respective UT element with respect to each of a plurality of axial locations of the conduit.
